(19) United States
(12) Patent Application Publication
(10) Pub. No.: US 2013/0194722 A1
(43) Pub. Date: Aug. 1, 2013

(54) SUPERCAPACITOR MODULE AND FABRICATION METHOD THEREOF

(71) Applicant: TAIWAN GREEN POINT ENTERPRISES CO., LTD, Taichung (TW)

(72) Inventors: Ray-Long TSAI, Taichung (TW); Hung-Chi WANG, Taichung (TW); Cheng-Yen WANG, Taichung (TW); Tung-Chuan CHEN, Taichung (TW); Hui-Mei CHANG, Taichung (TW)

(73) Assignee: TAIWAN GREEN POINT ENTERPRISES CO., LTD, Taichung (TW)

(21) Appl. No.: 13/746,628

(22) Filed: Jan. 22, 2013

Related U.S. Application Data
(60) Provisional application No. 61/589,937, filed on Jan. 24, 2012.

(30) Foreign Application Priority Data
Jun. 7, 2012 (TW) 101120457

(51) Int. Cl. H01G 11/16; H01G 11/84

(52) U.S. Cl. CPC H01G 11/16; H01G 11/84
USPC 361/502; 29/25.03

(57) ABSTRACT

A supercapacitor module includes: two main substrates each including an insulator plate, at least one electrical conductive unit formed on a surface of the insulator plate facing toward the other one of the two main substrates, and a circuit unit electrically connecting the electrical conductive unit to an external power; a separator film unit including a liquid-permeable insulating film disposed between the two main substrates; and an electrolyte filled between the two main substrates and cooperating with the liquid-permeable insulating film and the electrical conductive units of the two main substrates to form at least one supercapacitor between the two main substrates.

### CROSS-REFERENCE TO RELATED APPLICATION

This application claims benefit of U.S. provisional application no, 61/589,937, filed on Jan. 24, 2012.

### BACKGROUND OF THE INVENTION

1. Field of the Invention

This invention relates to a capacitor specials and a fabrication method thereof, more particularly to a supercapacitor module and a fabrication method thereof.

2. Description of the Related Art

A supercapacitor module is established by filling an electrolyte between two electrodes using the principle of an electrical double layer.

Referring to FIG. 1, a conventional supercapacitor module 1 mainly includes two electrodes 11 and an electrolyte 12 disposed between the two electrodes 11, and provides capacitance by polarizing the electrolyte. In detail, the conventional supercapacitor module 1 provides capacitance through the electrical double layer composed of an interface between the two electrodes 11 and the electrolyte 12.

The conventional supercapacitor module 1 has advantages such as compactness, lightness, faster charging and discharging speeds and higher charging and discharging times than a capacitor module, and thus has become a main target of research for energy storage devices.

However, there are several obstacles encountered by the conventional supercapacitor module 1. Firstly, since the electrolyte 12 between the two electrodes 11 is usually in a liquid form, if external force compresses the two electrodes 11 together, the two electrodes 11 are likely to come into contact with each other which results in short-circuit. Secondly, the conventional supercapacitor module 1 can alternatively increase energy storage capacity to raise energy density or lower internal resistance to raise power density. Thus, there is a tradeoff between the energy storage capacity and the power density.

### SUMMARY OF THE INVENTION

Therefore, an object of the present invention is to provide a supercapacitor module that can overcome the short-circuit problem associated with the prior art.

Another object of the present invention is to provide a supercapacitor module that can simultaneously raise power density and energy density.

According to a first aspect of this invention, a supercapacitor module comprises: two main substrates spaced apart from each other, and each including an insulator plate, at least one electrical conductive unit formed on a surface of the insulator plate facing toward the other one of the two main substrates, and a circuit unit electrically connecting the electrical conductive unit to an external power; a separator film unit including a liquid-permeable insulating film disposed between the two main substrates; and an electrolyte filled between the two main substrates and cooperating with the liquid-permeable insulating film and the electrical conductive units of the two main substrates to form at least one supercapacitor between the two main substrates.

According to a second aspect of this invention, a supercapacitor module comprises:

two main substrates spaced apart from each other, and each including an insulator plate, at least one electrical conductive unit formed on a surface of the insulator plate facing toward the other one of the two main substrates, and a circuit, unit electrically connecting the electrical conductive unit to an external, power;

at least one middle substrate disposed between the two main substrates, and including a middle plate unit, and at least one pair of electrical conductive units that are respectively disposed on two opposite surfaces of the middle plate unit, which respectively face the two main substrates, and that are electrically connected to each other;

a plurality of separator film units respectively including liquid-permeable insulating films disposed among the main and middle substrates; an electrolyte filled among the main and middle substrates, and cooperating with the separator film units and the electrical conductive unite of the main and middle substrates to form multiple supercapacitors connected to the circuit unit.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view showing a conventional supercapacitor module;

FIG. 2 is an exploded perspective view showing the first preferred embodiment of a supercapacitor module according to this invention;

FIG. 3 is a sectional view of the first preferred embodiment;

FIG. 4 is an equivalent circuit of the first preferred embodiment;

FIG. 5 is a flow chart showing a method for fabricating the first preferred embodiment of this invention;

FIG. 6 shows consecutive sub-steps of step 61 of the method shown in FIG. 5;

FIG. 7 shows consecutive sub-steps of step 62 of the method shown in FIG. 5;

FIG. 8 is a perspective view showing a semi-product for the supercapacitor module, that has two through holes formed in a packaging housing for introducing an electrolyte into the semi-product;

FIG. 9 shows introduction of the electrolyte into the semi-product by pressure difference;

FIG. 10 is a schematic view showing the second preferred embodiment of a supercapacitor module according to this invention;

FIG. 11 shows an equivalent circuit of the second preferred embodiment;

FIG. 12 is a flow chart showing a method for fabricating the second embodiment of this invention; and

FIG. 13 shows consecutive sub-steps of step 92 of the method shown in FIG. 12.

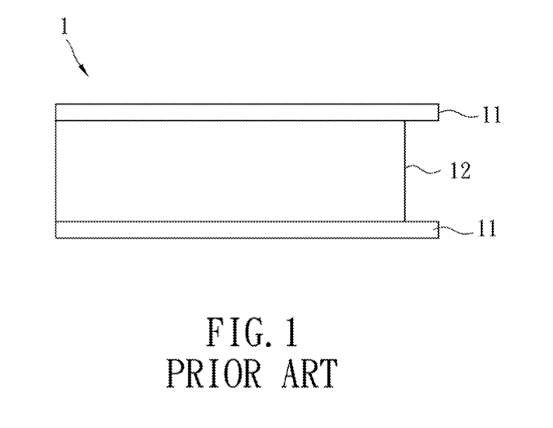

### DETAILED DESCRIPTION OF THE PREFERRED EMBODIMENTS

Before the present invention is described in greater detail, it should be noted herein that like elements are denoted by the same reference numerals throughout the disclosure.

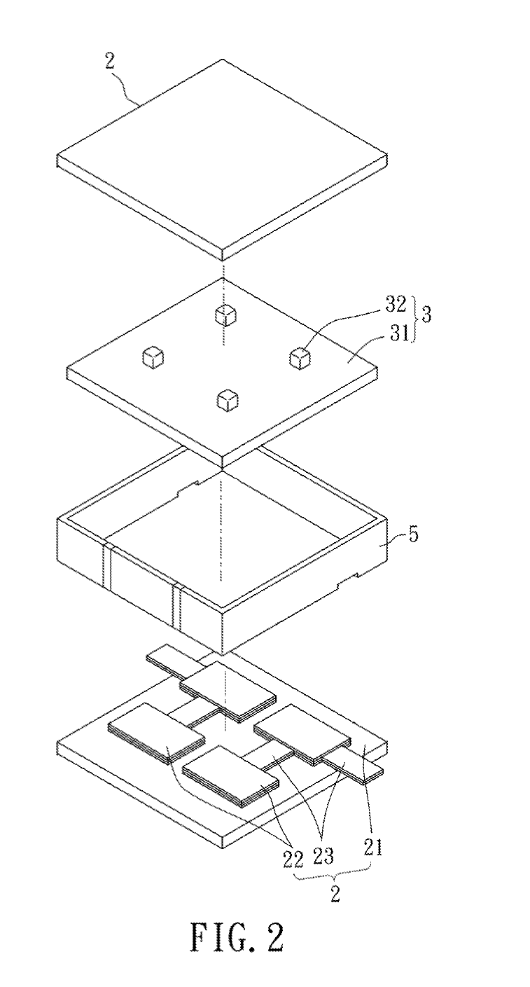

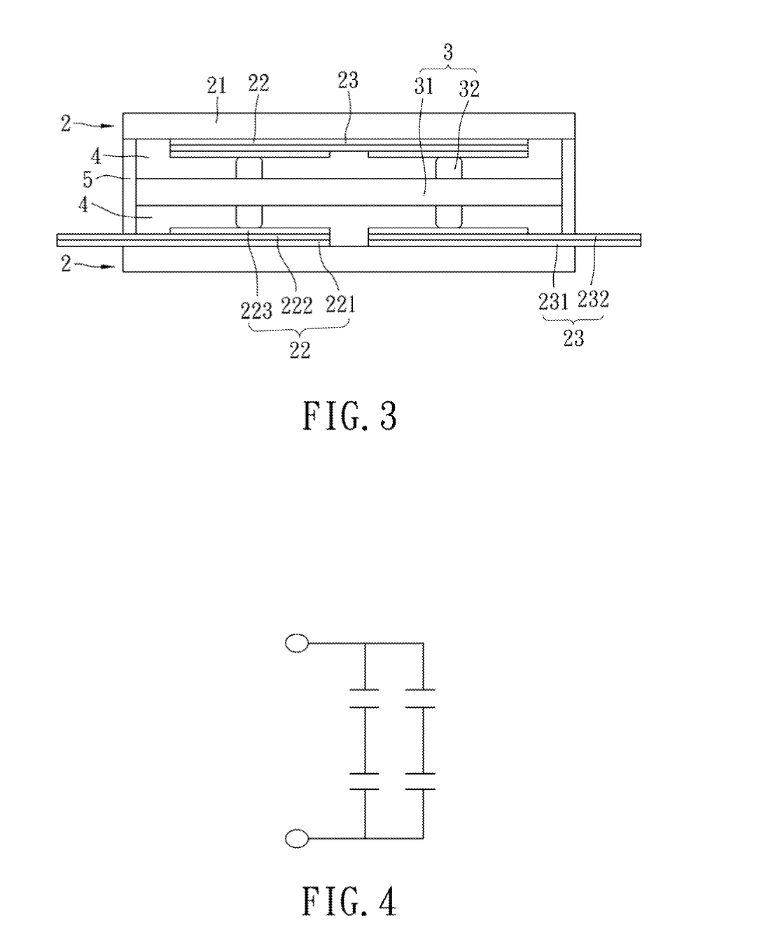

FIGS. 2 and 3 illustrate the first preferred embodiment of a supercapacitor module according to the present invention. The supercapacitor module includes two main substrates 2 spaced apart from each other, a separator film unit 3, an electrolyte 4, and a package body 5.

Each of the two main substrates 2 includes an insulator plate 21, at least one electrical conductive unit 22 disposed on a surface of the insulator plate 21 facing toward the other one of the two main substrates 2, and a circuit unit 23 electrically connecting the electrical conductive unit 22 to an external power.

In the first embodiment, each of the main substrates 2 includes an array of four of the spaced apart electrical conductive units 22 and four of the circuit-units 23. Each adjacent two of the electrical conductive units 22 are electrically interconnected in a predetermined pattern by the circuit units 23. Each of the electrical conductive units 22 has a first metal layer 221 disposed on the insulator plate 21, a second metal layer 222 disposed on the first metal layer 221 oppositely of the insulator plate 21, and an electrode layer 223 including a porous conductive material and disposed on the second metal layer 221 oppositely of the first metal layer 221. The electrical conductive units 22 on one of the two main substrates 2 respectively face and correspond in position to the electrical conductive units 22 on the other one of the two main substrates 2.

Preferably, the electrode layer 223 further includes an adhesive to uniformly bond the porous conductive material of the electrode layer 223 to a surface of the second metal layer 222 so as to lower contact resistance of each of the electrical conductive units 22.

Each of the circuit units 23 has a first metal layer 231 disposed on the insulator plate 21, and a second metal layer 232 disposed on a surface of the first metal layer 231 oppositely of the insulator plate 21. The first metal layers 231 and 221 of each of the circuit units 23 and each of the electrical conductive units 22 that are electrically connected are formed into one piece. The second metal layers 232, 222 of each of the circuit units 23 and each of the electrical conductive units 22 that are electrically connected are formed into one piece.

Preferably, the first metal layers 221, 231 of each of the electrical conductive units 22 and of each of the circuit units 23 are mainly made of a metal with good electrical conductivity, e.g., palladium. The second metal layers 222, 232 of each of the electrical conductive units 22 and of each of the circuit units 23 are mainly made of a material selected from the group consisting of aluminum, copper, nickel, gold, silver, titanium, and combinations thereof. The electrode layer 223 is made of a material selected from, the group consisting of carbon, active carbon, graphite, ruthenium oxide, manganese oxide, iron oxide, nickel oxide, and combinations thereof. The electrode layer 223 is bonded to the second, metal layer 222 by the adhesive. The adhesive is made of a material such as polytetrafluoroethylene.

It is noted that, in each of the electrical, conductive units 22, the first metal layer 221 can be directly contacted with, the electrode layer 223, i.e., the second metal layer 222 can be dispensed with.

The separator film unit 3 is an electrical insulator and includes a liquid-permeable insulating film 31 disposed between the two main substrates 2, and a plurality of protrusions 32 formed on the liquid-permeable insulating film 31. The liquid-permeable insulating film 31 is made of a material selected from the group consisting of polyethylene, polypropylene, and the combination thereof. The liquid-permeable insulating film 31 is fabricated into a porous structure. The protrusions 32 are made of a hard insulating material and project from two opposite surfaces of the liquid-permeable insulating film 31 so as to space the liquid-permeable insulating film 31 apart from other components, such as the two main substrates 2, to prevent short-circuit problem that may arise when the liquid-permeable insulating film 31 is damaged. In the first preferred embodiment, the protrusions 32 are mainly made of cured photoresist.

The electrolyte 4 is filled between the two main substrates 2 and cooperates with the liquid-permeable insulating film 31 and the electrical conductive units 22 of the two main substrates 2 to form a plurality of supercapacitors between the two main substrates 2. Specifically, in this embodiment, the electrical conductive units 22 of one of the two main substrates 2 are disposed at positions corresponding to the electrical conductive units 22 of the other one of the two main substrates 2 so as to form an array of the supercapacitors. The supercapacitors are connected in a predetermined electrical connection such as in series, in parallel, or the combination thereof through the circuit units 23 of the two main substrates 2. In the first preferred embodiment, four of the supercapacitors are formed and are electrically connected into two pairs of the supercapacitors in series. The two pairs of the supercapacitors are connected in parallel and are then connected to the external power (see FIG. 4).

The package body 5 is made of an insulating material, and cooperates with the two main substrates 2 to define a space for receiving the separator film unit 3 and the electrolyte 4.

When the external power provides electricity to the supercapacitors of the first preferred embodiment, charges are accumulated between the electrical conductive units 22 and the electrolyte 4 of each of the super capacitors to form an electrical double layer which can store a large amount of electric energy. Since the supercapacitor module of this invention is an array of the super capacitors with relatively high power and energy density, the supercapacitor module of this invention has advantages such as fast charge and discharge rate capability and improved energy storage capacity. Moreover, since the separator film unit 3 is disposed between the two main substrates 2, the short-circuit problem arising from direct contact of the electrical conductive units 22 of the two main substrates 2 can be prevented. The design of the protrusions 32 further prevents the liquid-permeable insulating film 31 from being damaged. Thus, likelihood of failure of the supercapacitor module can be effectively reduced.

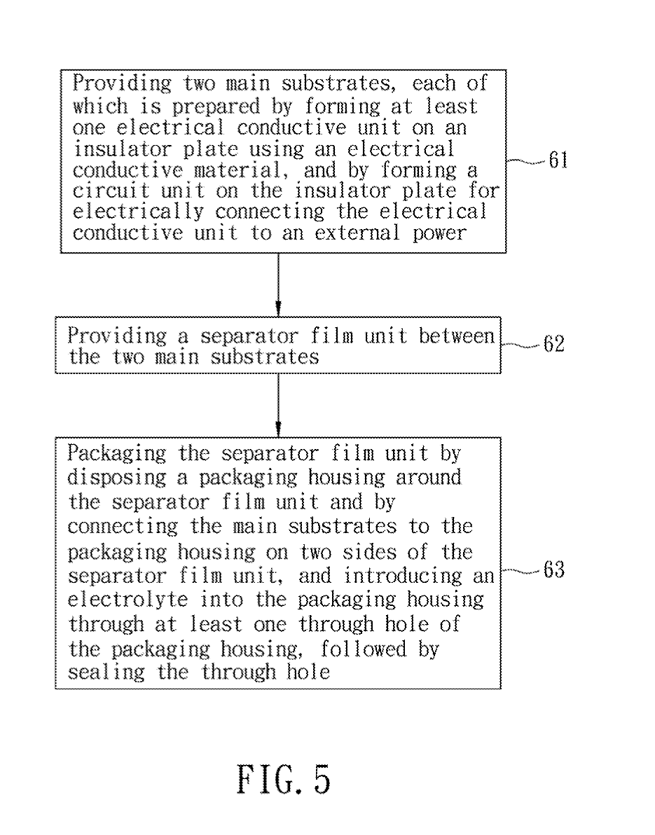

FIG. 5 illustrates a fabrication method fox the first preferred embodiment of the supercapacitor module of this invention.

The fabrication method comprises the steps of: providing the two main substrates 2 (step 61), providing the separator film unit 3 (step 62), and packaging the separator film unit 3 and introducing the electrolyte 4 (step 63).

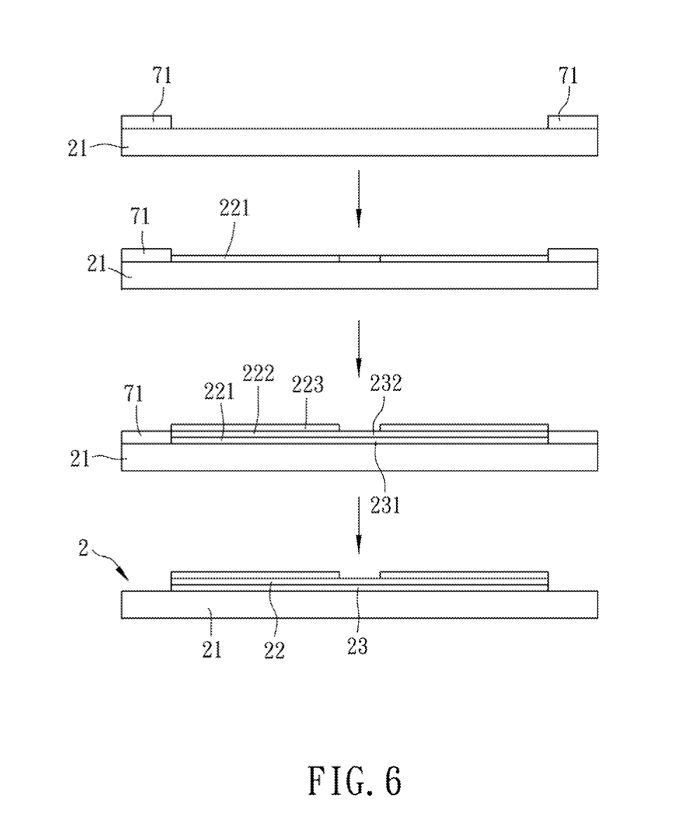

In step 61, each of the two main substrates 2 is prepared by forming the electrical conductive units 22 on the insulator plate 21, and forming the circuit units 23 on the insulator plate 21 for electrically connecting the electrical conductive units 22 to the external power. Specifically, referring to FIGS. 5 and 6, a patterned mask layer 71 is formed on the insulator plate 21 to expose a surface portion of the insulator plate 21. The patterned mask layer 71 has a predetermined pattern corresponding to that of the circuit units 23 and the electrical conductive units 22. In this method, the predetermined pattern for the electrical conductive units 22 is designed to have an array pattern. The insulator plate 21 provided with the mask layer 71 is dipped in a solution containing an active metal so that a first metal film is deposited on the surface region of the insulator plate 21 so as to form the first metal layers 221, 231 for the electrical conductive units 22 and the circuit units 23. A second metal film is formed on the surface of the first metal film by electroplating so as to form the second metal layers 222, 232 for the electrical conductive units 22 and the circuit units 23. The electrode layer 223 is formed by dissolving a precursor and the adhesive, e.g., polytetrafluoroethylene, in an ethanol-based organic solvent to obtain a coating solution. The precursor is selected from the group consisting of carbon, active carbon, graphite, ruthenium oxide, manganese oxide, iron oxide, nickel oxide, and combinations thereof. The coating solution is applied onto a surface of the second metal layer 222 by screen printing or inkjet printing, followed by heating so as to uniformly form the electrode layer 223 on the second metal layer 222. The electrode layer 223, and a part of the first and second films disposed underneath the electrode layer 223 (i.e., the first and second metal layers 221, 222) are cooperatively formed into the electrical conductive units 22. The remaining part of the first and second films, i.e., the first and second metal layers 231, 232, is formed into the circuit units 23. The mask layer 71 is removed and the main substrate 2 is thus obtained. In this method, the electrical conductive units 21 of one of the two main substrates 2 are disposed at positions corresponding to the electrical conductive units 21 of the other one of the two main substrates 2.

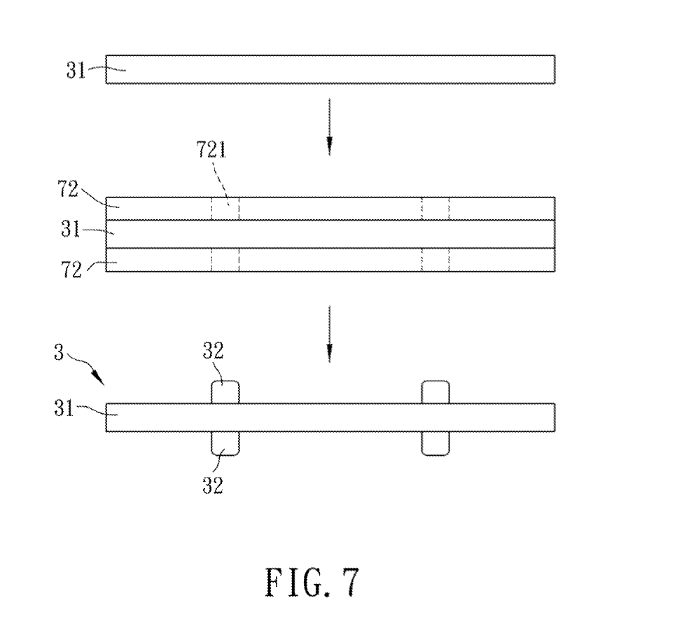

Referring to FIGS. 5 and 7, in step 62, the protrusions 32 are formed on the two opposite surfaces of the liquid-permeable insulating film 31. The liquid-permeable 31 and the protrusions 32 are formed into the separator film unit 3. Specifically, a photoresist material is applied on the two opposite surfaces of the liquid-permeable insulating film 31 which has a micro-porous structure so as to form photoresist layers 72. The photoresist layers 72 are patterned using a photolithography process to form the protrusions 32. Specifically, a predetermined region 721 of the photoresist layer 72 where the protrusions are to be formed is exposed and the remaining region except for the predetermined region 721 of the photoresist layer 72 is removed by a developer so as to form the protrusions 32 which are spaced apart from each other and which project from the two surfaces of the liquid-permeable insulating film 31. The separator film unit 3 is thus formed and is disposed between the two opposite main substrates 2 so that the electrical conductive units 22 of the two main substrates 2 face the separator film unit 3.

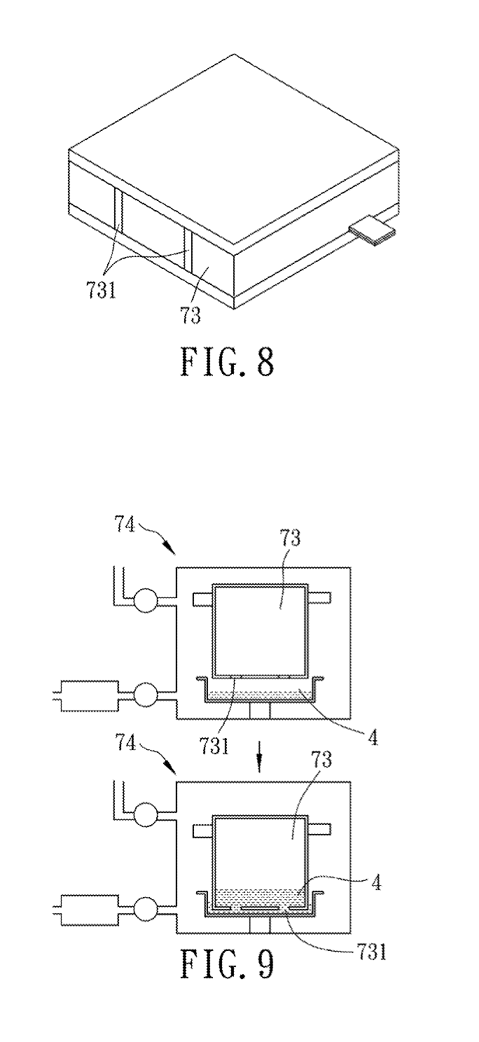

Referring to FIGS. 2, 5 and 8, in step 63, the insulator film unit 3 is packaged by the main substrates 2 and a packaging housing 73 having through holes 731. In this method, glue (not shown) is applied to a periphery of each of the two main substrates 2, and the two main substrates 2, the insulator film unit 3, and the packaging housing 73 are connected by hot-pressing to form a semi-product. Then, referring to FIG. 9, the semi-product is dipped into the electrolyte 4 in a vacuum device 74. Gas in the semi-product is drawn out through the through holes 731 until a pressure in the semi-product is lower than the external pressure. The electrolyte 4 then flows into the semi-product through the through holes 731 by virtue of pressure difference. The through holes 731 of the packaging housing 73 are then sealed with an UV glue, and an ultraviolet light is applied to cure the UV glue to form the packaging housing 73 into the package body 5. Thus, the supercapacitor module is completed.

In this method, since the electrolyte 4 is introduced into the semi-product by virtue of pressure difference, air gap phenomenon, attributed to bubbles formed in the supercapacitor module can be eliminated, thereby preventing reduction in electric energy storage capacity and possibility of electrical disconnection of the supercapacitor module. In addition, since the protrusions 32 are made of the photoresist material; no further insulator film is needed to be coated on the liquid-permeable insulating film 31 and no further etching step is required, thereby simplifying the fabrication process.

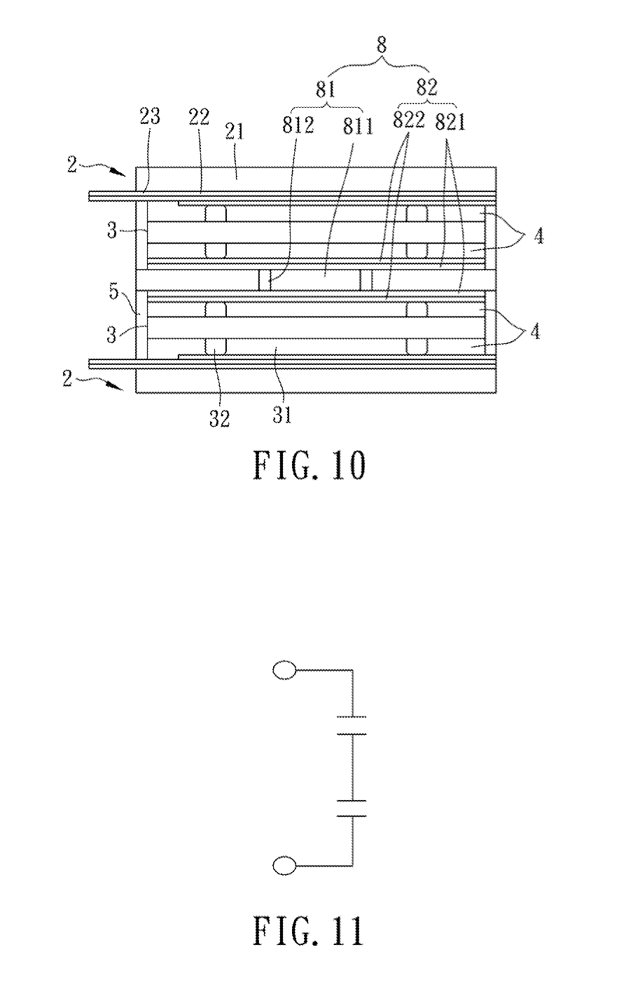

FIG. 10 shows the supercapacitor module of the second preferred embodiment according to this invention. The supercapacitor module of the second preferred embodiment is similar to that of the first preferred embodiment except that the supercapacitor module of the second preferred embodiment further comprises a middle substrate 8 disposed between the two main substrates 2, and a plurality of the separator film units 3 respectively including liquid-permeable insulating films 31 disposed among the main and middle substrates 2 and 8. In the second preferred embodiment, the main substrates 2 each of which includes an electrical conductive unit 22 and a circuit unit 23 are used for illustration.

The middle substrate 8 includes a middle plate unit 81, and at least one pair of electrical conductive units 82 that are respectively disposed on two opposite surfaces of the middle plate unit 31. The electrical conductive units 82 respectively face the two main substrates 2 and are electrically connected to each other.

The middle plate unit 81 has a body plate 811 and at least one connecting block 812 which is made of an electrically conductive material. The connecting block 312 electrically connects the pair of electrical conductive units 82. Each of the electrical conductive units 82 has a metal layer 821 formed on a surface of the middle plate unit 81, and an electrode layer 822 formed on a surface of the metal layer 821. The metal layer 821 and the electrode layer 822 are made of materials similar to or identical to those of the second metal layer 222 and the electrode layer 223 of each of the main substrates 2.

The package body 5 and the two main substrates 2 cooperatively package the middle substrate 8, the separator film units 3, and the electrolyte 4.

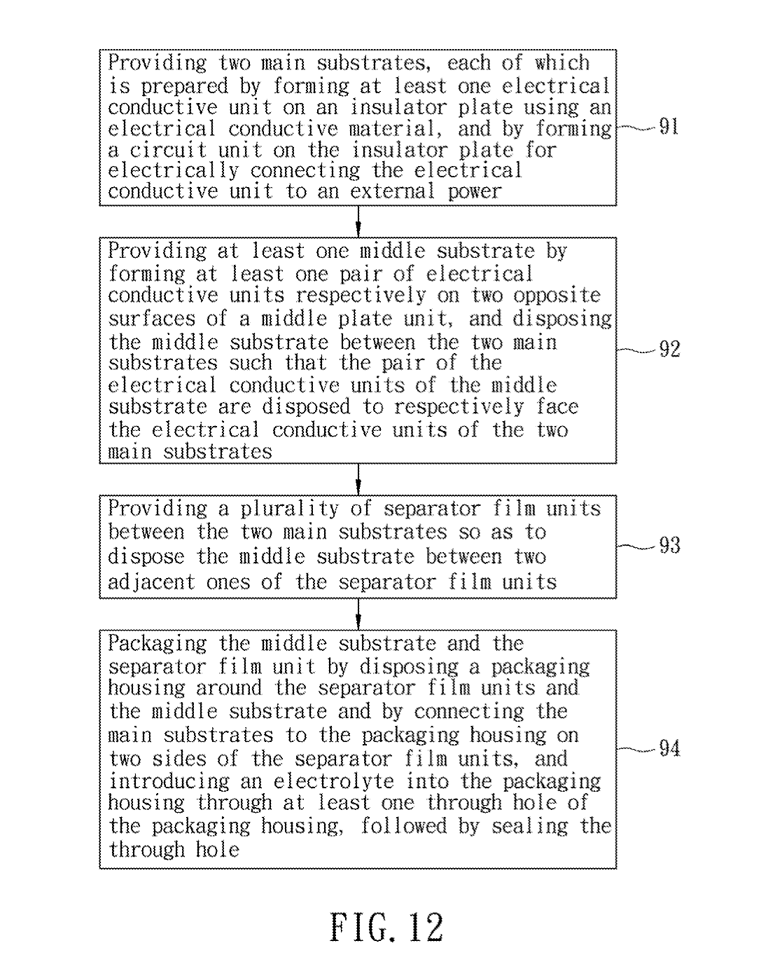

In the second preferred embodiment, one of the electrical conductive units 82 of the middle substrate 8, the adjacent one of the separator film units 3, the electrical conductive unit 22 of the adjacent one of the main substrates 2, and the electrolyte 4 are cooperatively formed into a supercapacitor. The other one of the electrical conductive units 82 of the middle substrate 8, the other one of the separator film units 3, the electrical conductive unit 22 of the other one of the main substrates 2, and the electrolyte 4 are cooperatively formed into another supercapacitor. The aforesaid two supercapacitors can be electrically connected to each other in series as shown in FIG. 12.

When an external power provides electricity to the supercapacitor module of the second preferred embodiment, charges are accumulated among the two electrical conductive units 22, 82 and the electrolyte 4 of each of the supercapacitors to form an electrical double layer which can store a large amount of electric energy. Since the supercapacitor module of this invention is an array of the super capacitors with relatively high power and energy density, the supercapacitor module of this invention has advantages such as fast charge and discharge rate capability and improved energy storage capacity. Moreover, since the electrical conductive units 22, 82 are isolated by the separator film unit 3, the short-circuit problem arising from a direct contact of the electrical conductive unit 22 of each of the main substrates 2 with the electrical conductive unit 82 of the middle substrate 8 can be prevented. Likelihood of failure of the supercapacitor module can be effectively reduced. In addition, the design of the protrusions 32 further prevents the liquid-permeable insulating film 31 from being damaged.

It is noted that the supercapacitor module of the second preferred, embodiment can comprises a plurality of middle substrates 8 and a plurality of separator film units 3. The separator film units 3 are disposed among the main and middle substrates 2, 3, and extend parallel to the main substrates 2. The separator film units 3 are respectively disposed between each of the main substrates 2 and the adjacent one of the middle substrates 8 and between two adjacent ones of the middle substrates 8. An arrangement sequence is main substrate 2—separator film unit 3—middle substrate 8—separator film unit 3—middle substrate 8—separator film unit 3— . . . —separator film unit 3—main substrate 2. The electrical conductive units 22 of the main substrates 2, the electrical conductive units 32 of the middle substrates 8, the separator film units 3, and the electrolyte 4 are cooperatively formed into a plurality of supercapacitors that are connected in series.

The protrusions 32 of each of the separator film units 3 project from the two opposite surfaces of the liquid-permeable insulating film 31 so as to space the liquid-permeable insulating film 31 apart from, any one of the main and middle substrates 2, 8, and thus the main and middle substrates 2, 8 are separated and the liquid-permeable insulating film 31 can be prevented from being damaged. Therefore, short-circuit in the aforesaid supercapacitor module can be alleviated.

It is further noted that when each of the main substrates 2 includes an array of the electrical, conductive units 22, the middle substrate 8 includes a plurality of the pairs of the electrical conductive units 82. The electrical conductive units 22 of one of the main substrates 2 respectively correspond in position to the pairs of the electrical conductive units 82 of the middle substrate 8 and the electrical conductive units 22 of the other one of the main substrates 2 so as to form a plurality of super capacitors that are connected in series, in parallel, or in the combination thereof.

FIG. 12 illustrates a fabrication method for the second preferred embodiment of the supercapacitor module of this invention. The fabrication method comprises the steps of: providing the two main substrates 2 (step 91), providing the middle substrate 8 (step 92), providing a plurality of the separator film units 3 (step 93), and packaging the middle substrate 8 and the separator film units 3 and introducing the electrolyte 4 (step 94).

In step 91, each of the two main substrates 2 is prepared by forming at least one electrical conductive unit 22 of an electrical conductive material and the circuit unit 23 on the insulator plate 21 for electrically connecting the electrical conductive unit 22 to an external power. Since the procedure in step Shi is the same as that of step 61 of the method for fabricating the first preferred embodiment, a detailed description thereof is omitted herein for the sake of brevity

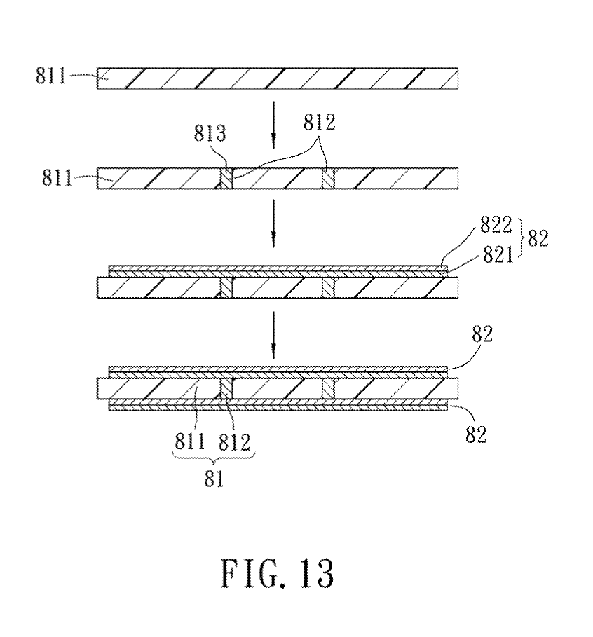

In step 92, at least one middle substrate 8 is provided by forming at least one pair of the electrical conductive units 82 respectively on two opposite surfaces of the middle plate unit 81. Specifically, referring to FIGS. 12 and 13, two penetrating holes 813 are formed in the body plate 811. Two connecting blocks 812 made of an electrically conductive material are formed in the penetrating holes 813. The body plate 811 and the connecting blocks 812 are formed into the middle plate unit 81. The metal layer 821 is formed on the two opposite surfaces of the middle plate unit 81 by electroplating, and the electrode layer 822 is formed on a surface of the metal layer 821 so as to form the electrical conductive units 82 of the middle substrate 8. The processes for fabricating the metal layer 821 and the electrode layer 822 are respectively similar to those of the second metal layer 222 and the electrode layer 223 of each of the main substrates 2 in step 61. The two electrical conductive units 82 disposed on the two opposite surfaces of the middle plate unit 81 are electrically connected to each other through the connecting blocks 812, thereby completing the middle substrate 8. The middle substrate 8 is disposed between the two main substrates 2 such that the pair of the electrical conductive units 82 of the middle substrate 8 are disposed to respectively face the electrical conductive units 22 of the two main substrates 2.

In step 93, two of the separator film units 3 are provided, each of which is formed by forming a plurality of protrusions 32 on two opposite surfaces of the liquid-permeable insulating film 31. The process for fabricating the separator film units 3 is similar to that in step 62 of the method for fabricating the first-preferred embodiment.

In step 94, the two separator film units 3 are disposed between the two main substrates 2, and the middle substrate 8 is disposed between the two separator film units 3. The separator film units 3 and the middle substrate 8 are packaged by the two main substrates 2 and a packaging housing 73. In this method, glue is applied, to peripheries of the two main substrates 2 and the middle substrate 8, and the packaging housing 73, the two main substrates 2, the separator film units 3, and the middle substrate 8 are connected using a hot-pressing process to form a semi-product. The procedure for introducing the electrolyte 4 into the semi-product is similar to that set forth in step 63 of the method for fabricating the first preferred embodiment.

To sum up, the supercapacitor module according to this invention includes an array of supercapacitors connected in series or in parallel. The supercapacitor module thus has high power density and high energy density. By virtue of the separator film unit 3, short-circuit problem attributed to contact of the electrical conductive units 22 of the main substrates 2 with the electrical conductive units 82 of the middle substrate 8 can be avoided. Moreover, the protrusions 32 of the separator film unit 3 can be used to prevent damage to the separator film unit 3 by the main substrates 2 and the middle substrate 8. In addition, the electrolyte 4 is introduced into the supercapacitor module through pressure difference, thereby avoiding air gap effect.

While the present invention has been described in connection with what are considered the most practical and preferred embodiments, it is understood that this invention is not limited to the disclosed embodiments but is intended to cover various arrangements included within the spirit and scope of the broadest interpretations and equivalent, arrangements.

What is claimed is:

1. A supercapacitor module, comprising:
two main substrates spaced apart from each other, and each including an insulator plate, at least one electrical conductive unit formed on a surface of said insulator plate facing toward the other one of said two main substrates, and a circuit unit electrically connecting said electrical conductive unit to an external power;
a separator film unit which includes a liquid-permeable insulating film and is disposed between said two main substrates; and
an electrolyte filled between said two main substrates and cooperating with said liquid-permeable insulating film and said electrical conductive units of said two main substrates to form at least one supercapacitor between said two main substrates.

2. The supercapacitor module of claim 1, wherein said separator film unit further includes a plurality of protrusions projecting from two opposite surfaces of said liquid-permeable insulating film so as to space said liquid-permeable insulating film apart from said two main substrates.

3. The supercapacitor module of claim 2, wherein each of said two main substrates includes an array of said electrical conductive units, said electrical conductive units on one of said two main substrates respectively corresponding in position to said electrical conductive units on the other one of said two main substrates.

4. The supercapacitor module of claim 3, wherein said electrical conductive unit of each of said main substrates has a metal layer disposed on said insulator plate, and an electrode layer including a porous conductive material and disposed on said metal layer oppositely of said insulator plate.

5. A supercapacitor module, comprising:
two main substrates spaced apart from each other, and each including an insulator plate, at least one electrical conductive unit formed on a surface of said insulator plate facing toward the other one of said two main substrates, and a circuit unit electrically connecting said electrical conductive unit to an external power;
at least one middle substrate disposed between said two main substrates, and including a middle plate unit, and at least one pair of electrical conductive units that are respectively disposed on two opposite surfaces of said middle plate unit, which respectively face said two main substrates, and that are electrically connected to each other;
a plurality of separator film units respectively including liquid-permeable insulating films disposed among said main and middle substrates; and
an electrolyte filled among said main and middle substrates, and cooperating with said separator film units and said electrical conductive units of said main and middle substrates to form multiple supercapacitors connected to said circuit unit.

6. The supercapacitor module of claim 5, wherein each of said separator film units further includes a plurality of protrusions projecting from two opposite surfaces of said liquid-permeable insulating film to space said liquid-permeable insulating film apart from any one of said main and middle substrates.

7. The supercapacitor module of claim 6, which comprises a plurality of said middle substrates that are separately disposed between said two main substrates, said separator film units being disposed among said main and middle substrates.

8. The supercapacitor module of claim 5, wherein each of said two main substrates includes an array of said electrical conductive units, said middle substrate including a plurality of said pairs of said electrical conductive units, said electrical conductive units of said one of said main substrates respectively corresponding in position to said pairs of said electrical conductive units of said middle substrate, and said electrical conductive units of the other one of said main substrates.

9. The supercapacitor module of claim 8, wherein said electrical conductive unit of each of said main substrates has a metal layer disposed on said insulator plate, and an electrode layer including a porous conductive material and disposed on said metal, layer oppositely of said insulator plate.

10. A method for fabricating a supercapacitor module, comprising:
(a) providing two main substrates, each of which is prepared by forming at least one electrical conductive unit on an insulator plate using an electrical conductive material, and by forming a circuit unit on the insulator plate for electrically connecting the electrical conductive unit to an external power;
(b) providing a separator film unit between the two main substrates;
(c) packaging the separator film unit by disposing a packaging housing around the separator film unit and by connecting the main substrates to the packaging housing on two sides of the separator film unit; and
(d) introducing an electrolyte into the packaging housing through at least, one through hole of the packaging housing, followed by sealing the through hole.

11. The method of claim 10, wherein the separator film unit has a plurality of protrusions formed on a liquid-permeable insulating film such that the protrusions project from two opposite surfaces of the liquid-permeable insulating film.

12. The method of claim 10, wherein an array of the electrical conductive units are formed on the insulator plate of each of the main substrates, and the electrical conductive units of one of the two main substrates are disposed at positions corresponding to the electrical conductive units of the other one of the two main substrates.

13. The method of claim 11, wherein the protrusions are formed by coating a photoresist material on the liquid-permeable insulating film to form a photoresist layer, and patterning the photoresist layer using a photolithography process so as to form the photoresist layer into the protrusions.

14. The method of claim 10, wherein step (a) is implemented by:
(a1) forming a patterned mask layer on the insulator plate to expose at least one surface portion of the insulator plate;
(a2) dipping the insulator plate in a solution containing an active metal such that a first metal film made of the active metal is formed on the surface portion of the insulator plate;
(a3) electroplating a second metal film on the first metal film, the second metal film being made of a material selected from the group consisting of aluminum, copper, nickel, gold, silver, titanium, and combinations thereof; and
(a4) forming an electrode layer on a part of the second metal film, the electrode layer including a porous conductive material;
wherein the electrical conductive unit includes the electrode layer and a part of the first and second metal films that has the electrode layer formed thereon, and the circuit unit includes a remaining part of the first and second metal films.

15. A method for fabricating a supercapacitor module, comprising:
(a) providing two main substrates, each of which is prepared by forming at least one electrical conductive unit on an insulator plate using an electrical conductive material, and by forming a circuit unit on the insulator plate for electrically connecting the electrical conductive unit to an external power;
(b) providing at least one middle substrate by forming at least one pair of electrical conductive units respectively on two opposite surfaces of a middle plate unit;
(c) disposing the middle substrate between the two main substrates such that the pair of the electrical conductive units of the middle substrate are disposed to respectively face the electrical conductive units of the two main substrates;
(d) providing a plurality of separator film units between the two main substrates;
(e) disposing the middle substrate between two adjacent ones of the separator film units;
(f) packaging the middle substrate and the separator film units by disposing a packaging housing around the separator film units and the middle substrate and by connecting the main substrates to the packaging housing on two sides of the separator film units; and
(g) introducing an electrolyte into the packaging housing through at least one through hole of the packaging housing, followed by sealing the through hole.

16. The method of claim 15, wherein each of the separator film units is formed by forming a plurality of protrusions on a liquid-permeable insulating film such that the protrusions project from two opposite surfaces of the liquid-permeable insulating film to space the liquid-permeable insulating film apart from any one of the main and middle substrates.

17. The method of claim 15, wherein the middle plate unit is formed by forming at least one penetrating hole, and filling an electrical conductive material in the penetrating hole such that the pair of electrical conductive units are electrically connected to each other.

18. The method of claim 15, wherein an array of the electrical conductive units are formed on the insulator plats of each of the main substrates, a plurality of the pair of electrical conductive units being formed on the middle plate unit, the electrical conductive units of one of the main substrates being disposed respectively corresponding in position to the pairs of electrical conductive units of the middle substrate, and the electrical, conductive units of the other one of the main substrates.

19. The method of claim 16, wherein the protrusions are formed by coating a photoresist material on the liquid-permeable insulating film to form a photoresist layer, and patterning the photoresist layer using a photolithography process so as to form the photoresist layer into the protrusions.

20. The method of claim 15, wherein step (a) is implemented by:
(a1) forming a patterned mask layer on the insulator plate to expose at least one surface portion of the insulator plate;
(a2) dipping the insulator plate in a solution containing an active metal such that a first metal film made of the active metal is formed on the surface portion of the insulator plate;
(a3) electroplating a second metal film on the first metal film, the second metal film being made of a material selected from the group consisting of aluminum, copper, nickel, gold, silver, titanium, and combinations thereof; and
(a4) forming an electrode layer on a part of the second metal film, the electrode layer including a porous conductive material;
wherein the electrical conductive unit includes the electrode layer and a part of the first and second metal films that has the electrode layer formed thereon, and the circuit unit includes a remaining part of the first and second metal films.
